(19) United States
(12) Patent Application Publication
(10) Pub. No.: US 2012/0089442 A1
(43) Pub. Date: Apr. 12, 2012

(54) DRIVING WHILE DISTRACTED ACCOUNTABILITY AND REWARDS SYSTEMS AND METHODS

(75) Inventors: MIKAEL OLSSON, Redding, CA (US); Nicolas Acuna, Redding, CA (US)

(73) Assignee: SweMex LLC, Redding, CA (US)

(21) Appl. No.: 12/903,151

(22) Filed: Oct. 12, 2010

(51) Int. Cl. G06Q 30/00

(52) U.S. Cl. 705/14.1

(57) ABSTRACT

A system for driving while distracted accountability and rewards, in one example embodiment, comprises a user interface between an administrator and an accountability and rewards service, a communication module to receive, from the administrator via the user interface, parameters to establish an accountability and rewards policy for a user associated with a mobile device, with the parameters including a mobile device identifier, a policy enforcement module to apply the accountability and rewards policy to the user associated with the mobile device, with the policy enforcement module determining whether or not the user is complying with the accountability and rewards policy by detecting an attempt to use the mobile device while driving a vehicle at a speed exceeding a predetermined threshold speed. The policy enforcement module may determine, using an accelerometer native to the mobile device, that an orientation of the mobile device is face down, and, based on the determination, establish that the user is complying with the accountability and rewards policy. Alternatively, the compliance is established based on whether a mobile application associated with the policy is running in the foreground or background. The system may further include a reward module to selectively submit reward amounts to a reward center in exchange for the ability of the user to redeem the reward amounts through the reward center, based on the compliance for a predetermined period of time.

### FIELD

This application relates generally to data processing in the field of driving safety and more specifically to driving while distracted accountability and rewards systems and methods.

### BACKGROUND

Mobile device use while driving is common but dangerous. Nevertheless, some drivers compose, send, or read text messages and email, or make other similar use of the internet on a mobile device, while operating a motor vehicle. The practice has been ruled as the cause of some motor vehicle accidents and has been outlawed or restricted in some places. In some cases, restrictions are only directed to minors because they are more likely to engage in operating mobile devices while driving, thereby leading to increased distraction behind the wheel.

Some existing solutions utilize the Global Positioning System (GPS) signals to place restrictions on mobile device usage. This approach inhibits mobile device usage once the vehicle's speed exceeds a certain threshold. However, none of the existing solutions are designed to improve the driving habits of mobile device users in a positive way, by providing rewards for maintaining safety.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computer-implemented method for driving while distracted accountability and rewards comprises utilizing a user interface between a administrator and an accountability and rewards service, receiving, from the administrator, via the user interface, parameters to establish an accountability and rewards policy for a user associated with a mobile device, the parameters including a mobile device identifier, applying the accountability and rewards policy to the user associated with the mobile device, a policy enforcement module determining whether or not the user is complying with the accountability and rewards policy by detecting an attempt to use the mobile device while driving a vehicle at a speed exceeding a predetermined threshold speed, and, based on a compliance with the accountability and rewards policy for a predetermined period of time, selectively submitting reward amounts to an reward center in exchange for an ability by the user to redeem the reward amounts through an reward center. The rewards amounts may be reduced in response to a noncompliance occurrence. One or more persons specified by the administrator may be notified of the noncompliance occurrence. The speed of the vehicle may be determined based on information provided by a GPS system native to the mobile device.

In an example, a mobile application may be installed on the mobile device to allow the user notifying the policy enforcement module that the user is not driving the vehicle, thereby disabling the accountability and rewards policy. The notification may be enabled by flipping the mobile device. The flipping may be detected by using an accelerometer native to the mobile device. The mobile application may display information related to compliance with the accountability and rewards policy. The ability by the user to redeem the reward amounts through an reward center may be communicated to the user via email, and the communication may include a code. The mobile device may allow the sharing of statistics associated with the compliance with the accountability and rewards policy.

In further examples, the above method steps may be stored on a machine-readable medium comprising instructions, which, when implemented by one or more processors, perform the steps. In yet further examples, subsystems, or devices can be adapted to perform the recited steps. Other features, examples, and embodiments are described below.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing a network environment within which driving while distracted accountability and rewards systems and methods are implemented, in accordance with an example embodiment;

FIG. 2 is a block diagram showing an accountability and rewards engine, in accordance with an example embodiment;

FIG. 3 is a flow chart showing a driving while distracted accountability and rewards method, in accordance with an example embodiment;

FIG. 4 is a block diagram showing an reward center, in accordance with an example embodiment;

FIGS. 5 is a flow chart showing a driving while distracted accountability and rewards method, in accordance with an example embodiment;

FIGS. 6 is a flow chart showing another driving while distracted accountability and rewards method, in accordance with an example embodiment;

FIG. 7 is a block diagram showing a notification matrix, in accordance with an example embodiment;

FIGS. 8-12 are block diagrams showing a sign up user interface, in accordance with an example embodiment;

FIGS. 13-20 are block diagrams showing a user interface, in accordance with an example embodiment;

FIG. 21-28 are block diagrams showing an administrative user interface, in accordance with an example embodiment; and

FIG. 29 is a diagrammatic representation of an example machine in the form of a computer system within which a set of instructions for causing the machine to perform any one or more of the methodologies discussed herein is executed.

### DETAILED DESCRIPTION

The present invention relates generally to improving driving safety, and more specifically to accountability and reward systems and methods designed to improve the driving habits of mobile device users.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In one example embodiment, systems and methods may provide an accountability system that allows parents to know when and if their minor children are driving while distracted by mobile device use. The system may be synchronized with the mobile device's native location detection system to enable determination of the velocity of the moving vehicle. Once the velocity of the mobile device is determined to exceed a predetermined threshold velocity (e.g., 5 mph), the system may assume that the driving has commenced. Upon determining that the driving has commenced, a mobile application, provided by the systems and methods, may start operating in the foreground of the mobile device. The system may be configured to determine when the mobile application is taken from the foreground to the background. Owning to the multitasking capability of the mobile device, the mobile application does not stop performing when it is taken the background. When the mobile application is taken to the background, it can send one or more push notifications (e.g., to parent's telephone numbers) stating that the minor child is using the mobile device while driving

While the mobile application operates in the foreground, it may show a blank screen that leaves the driver unable to interact with the application. When the velocity of the vehicle is reduced below a predetermined threshold velocity or the vehicle comes to a stop, the mobile application may display the amount of time that the user has gone without using the mobile device while driving. The system may periodically send information to the parents. The parents may provide rewards for practicing safe driving habits.

For example, in order to provide the rewards, the parents may open an account and synchronize the account with a reward center (e.g., a digital media store such as iTunes). The parents may choose a periodic (e.g., monthly or weekly) amount in reward center credits to reward to their minor child for practicing safe driving. The amount of the reward may be reduced if the child breaks the rule and uses the mobile device while driving. At the end of each reward period, the system may automatically submit the remaining reward credits to the reward center in exchange for the ability (e.g., access code) to redeem the credits. A code to redeem the credits may be emailed, texted or pushed to the minor child through the mobile application.

The system does not restrict access to other mobile applications while efficiently reducing usage of mobile devices while driving through accountability and reward system. In addition to safe driving and parental peace of mind, the system may actively change driving behavior for life.

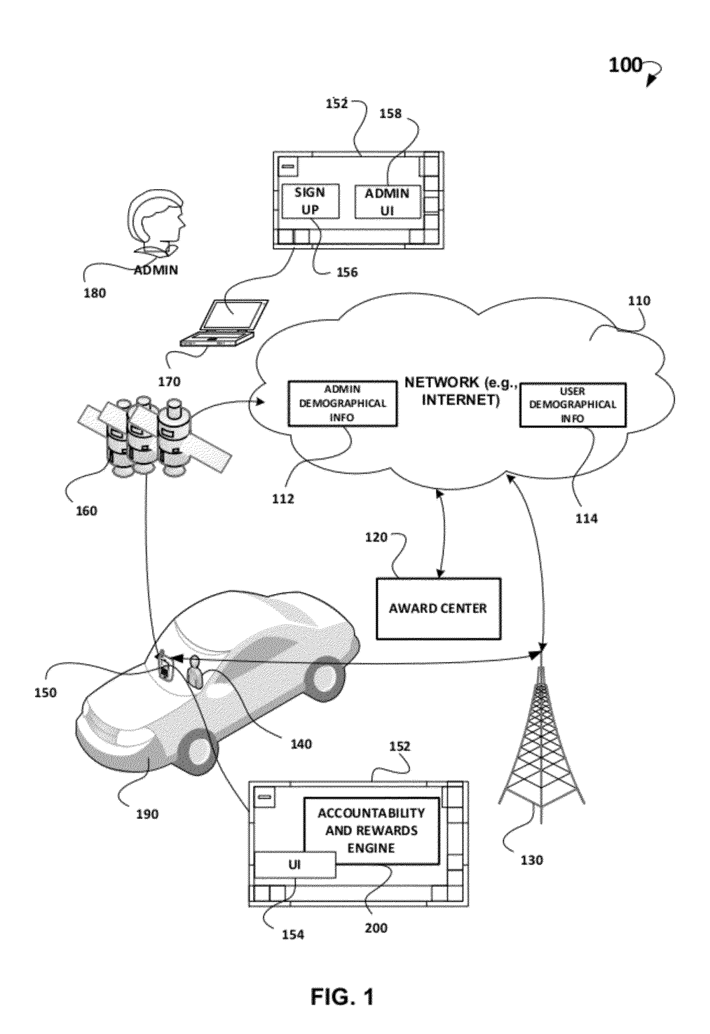

FIG. 1 is a block diagram showing a network environment 100 within which driving while distracted accountability and rewards systems and methods are implemented, in accordance with an example embodiment. As shown in FIG. 1, the environment 100 may include a network 110, a reward center 120, a cellular network 130, a user 140, a mobile device 150, satellite network 160, a computer 170 (which can be any internet-enabled device), an administrator 180, a vehicle 190, and an accountability and rewards engine 200.

The network 110 is preferably the Internet, but can be any network capable of communicating data between devices can be used with the present system. In addition to the Internet, suitable networks can also include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection. Other example networks include an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection. Furthermore, communications can also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digit networking.

The network 110 may include various cloud databases such as an administrator demographical database 112 and a user demographical database 114. The administrator demographical database 112 and user demographical database 114 may be deployed to the network 110. These databases may organize and categorize demographical information associated with the administrator 170 and the user 150. The user demographical database 114 may include data associated with driving patterns of the user 150.

The accountability and rewards engine 200 may be designed as a system that allows the administrator 180 to know when and if the user 140 is driving the vehicle 190 while distracted by the use of the mobile device 150. The mobile device 150 may include but is not limited to, a smartphone (e.g., Blackberry and iPhone), a tablet Personal Computer (PC), a gaming device, a portable media player, an automobile computer system, and Internet enabled television (TV). The mobile device 150 may provide the user 140 with Internet access. A mobile application 152 may be synchronized with a native GPS system installed on the mobile device 150, which periodically reports its location and, consequently, the location of the vehicle 190. The GPS system may utilize signals received from the satellite network 160 to determine the location of the vehicle 190.

The speed of the vehicle 190 may be determined based on the location of the vehicle 190 at various times. The mobile application 152 may run on the mobile device 150. The application 152 may be facilitated by the accountability and rewards engine 200 running on the mobile device 150. The accountability and rewards engine 200 may receive the locations and times via the cellular network 130. As mentioned above, the network environment 100 may include the satellite network 160 and/or the cellular network 130, both of which may be utilized for transmitting and receiving positional and operational data to the accountability and rewards engine 200. The satellite network 160 and/or the cellular network 130 may also receive and transmit the positional and operational data from the mobile device 150.

When it is determined that the vehicle speed exceeds a predetermined threshold speed (e.g., 5 mph), the user 140 may be notified with an alert and asked to indicate whether the user 140 is a driver or a passenger of the vehicle 190. If the user 140 indicates that he or she is the driver, the mobile application 152 may start running in the foreground. In some example embodiments, the driver has to flip the mobile device 150 over in order to avoid notifications being sent to one or more parties specified by the administrator 180. Because mobile device 150 may have a accelerometer built in, it can be determined whether the mobile device is positioned face down.

The mobile application 152 may be aware that it is running in the foreground. The mobile application 152 may still run when it is taken to the background because of the operating system's multitasking capabilities. Once it is determined that the user 140 uses the mobile device 150 while driving the vehicle 190, notifications may be sent to one or more phones specified by the administrator 180 stating that the user 140 is engaging in driving while distracted. While the mobile application 150 is in the foreground, it may show a blank screen, giving the user 140 nothing to interact with. When the speed of the vehicle 190 is reduced below the predetermine threshold speed, the amount of time that the user 140 has gone without driving while distracted may be displayed on a user interface 154.

Additionally, reward amounts may be synchronized with an administrator reward account. The administrator 180 may choose a monthly amount in reward credit to reward to the user 140 for demonstrating safe driving habits. After each driving while distracted notification, the reward amount may decrease at a predetermined rate. In some example embodiments, the reward amount may accrue at a predetermined rate if the user 140 does not incur any violations. At the end of a predetermined period, the accountability and rewards engine 200 may submit the remaining reward to the reward center 120 in exchange for a redeemable code that can be emailed, texted, or pushed to the mobile device 150.

The administrator 180 may start the process by downloading the mobile application 152 from an application store or directly from a distributor of the mobile application 152. The administrator may utilize a mobile device or a personal computer 170 to download the mobile application 152. The administrator 180 may use a sign up interface 156 to adjust administrative settings of the mobile applications 152. A protected payment gateway may be used to ensure the security of the sign up process. Using the sign up interface 156, the administrator 180 may set password protection for the mobile application 152 and for locations settings of the mobile device 150. Additionally, the administrator 180 may provide telephone numbers to be notified in the event of a driving while distracted. The administrator 180 may turn a reward system on or off and choose a reward system monetary amount

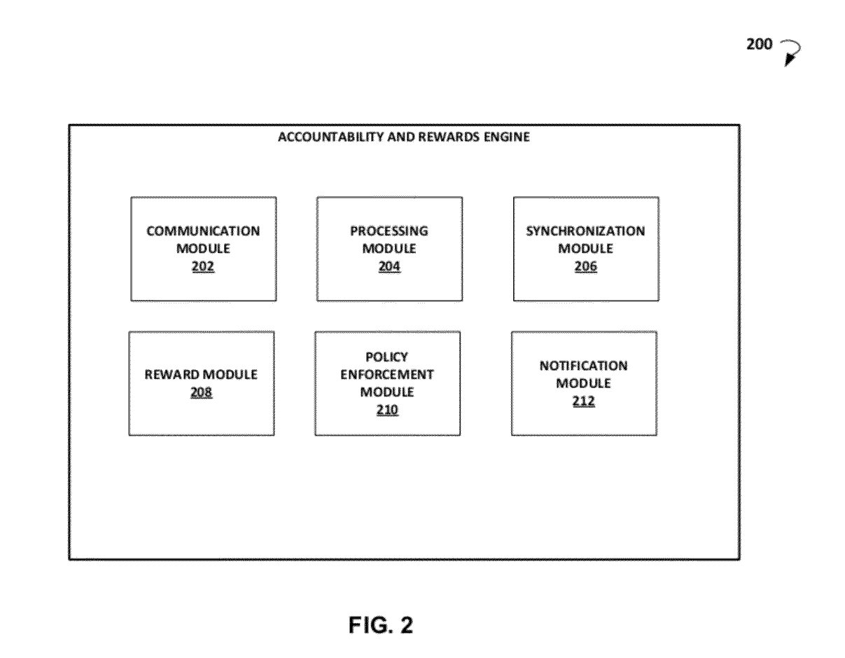

FIG. 2 is a block diagram showing the accountability and rewards engine 200, in accordance with an example embodiment. As shown in FIG. 2, the accountability and rewards engine 200 may include a communication module 202, a processing module 204, a synchronization module 206, a reward module 208, a policy enforcement module 210, and a notification module 212. The rewards engine 200 may be running on the mobile device 150 and/or be a part of the mobile application 152. The communication module 202 may receive from the administrator 180 parameters to establish an accountability and rewards policy for a user associated with a mobile device. The parameters may include a mobile device identifier such as a telephone number or a MAC address. The mobile application 152 may determine the speed of the vehicle 190 based on the data provided by the general location detection system native to the mobile device 150 and relay the information to the processing module 204 of the accountability and rewards engine 200. Based on this information, the processing module 204 may determine whether to activate the accountability and rewards policy.

Additionally, the processing module 204 may disable the accountability and rewards policy if the user 140 notifies the accountability and rewards sever 200 that the user 140 is not driving the vehicle 190. In some example embodiments, the user 140 may notify the accountability and rewards sever 200 by flipping the mobile device 150.

The synchronization module 206 may allow synchronization of the administrative user reward account with the reward center 120. The reward module 208 may submit reward amounts to the reward center 120 in exchange for the ability by the user 140 to redeem the reward amounts through the reward center 120. The reward module may also ensure that the rewards amounts are reduced in response to a failure to comply with the accountability and rewards policy. The policy enforcement module 210 may apply the accountability and rewards policy to the user 140 associated with the mobile device 150. The policy enforcement module 210 may determine whether the user 140 is complying with the accountability and rewards policy by detecting an attempt to use the mobile device 150 while driving the vehicle 190 at a speed exceeding a predetermined threshold speed. The notification module 212 may ensure that one or more persons specified by the administrator 180 are notified of the noncompliance with the accountability and rewards policy.

It will be appreciated by one of ordinary skill that examples of the foregoing modules may be virtual, and instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of various embodiments.

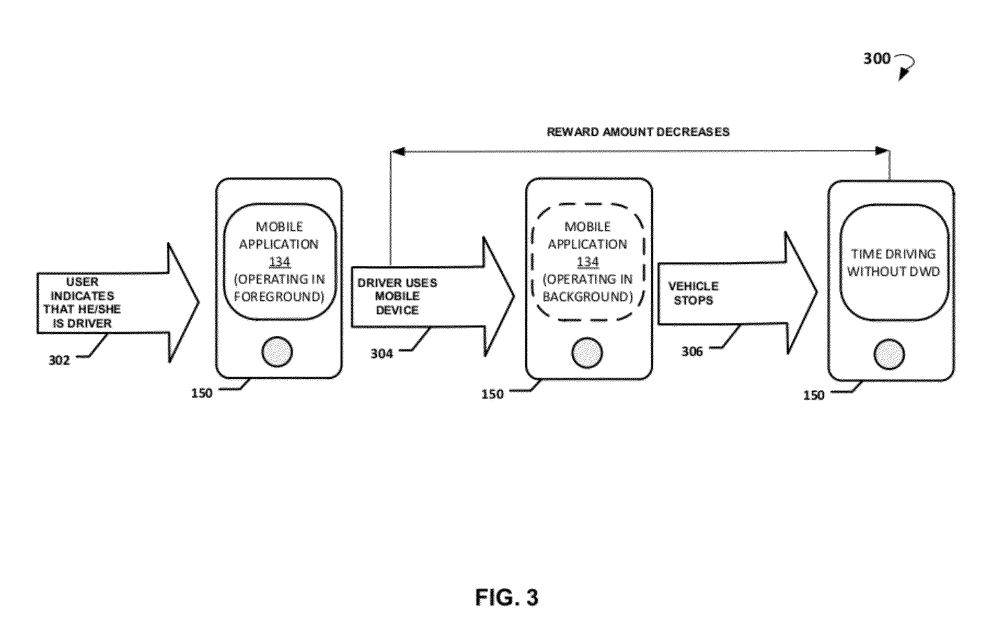

FIG. 3 is a flow chart showing a driving while distracted accountability and rewards method 300, in accordance with an example embodiment. The method 300 may be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides at the accountability and rewards engine 200 illustrated in FIG. 2.

As shown in FIG. 3, the method 300 may commence at operation 302 when the user 140 indicates that he or she is the driver of the vehicle 190. The mobile application 152 may be operating in the foreground until the user 140 uses the mobile device 150. Once the user 140 uses the mobile device 150, the mobile application 152 starts operating in the background and the reward amounts decreases by one third. If no driving while distracted violations are detected, the reward amounts will not decrease. In some example embodiments, the reward amounts may increase if no driving while distracted violations are detected. When driving while distracted is detected and the mobile application starts operating in the background, notifications may be sent the one or more persons specified by the administrator 180. At the end of the trip, the cumulative time driving without violations may be displayed.

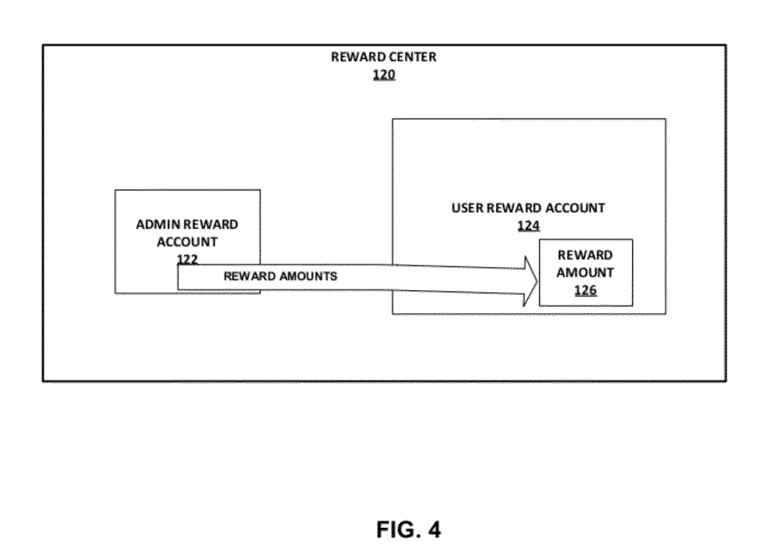

FIG. 4 is a block diagram showing the reward center 120, in accordance with an example embodiment. As shown, the reward center 120 may include an administrative reward account 122 and the user reward account 124. If the user 140 satisfies the conditions set by the administrator 180, reward amounts 126 may be rewarded to the user 140. The reward amounts may be paid for by the administrator 180 and taken out of the administrative reward account during the reward process.

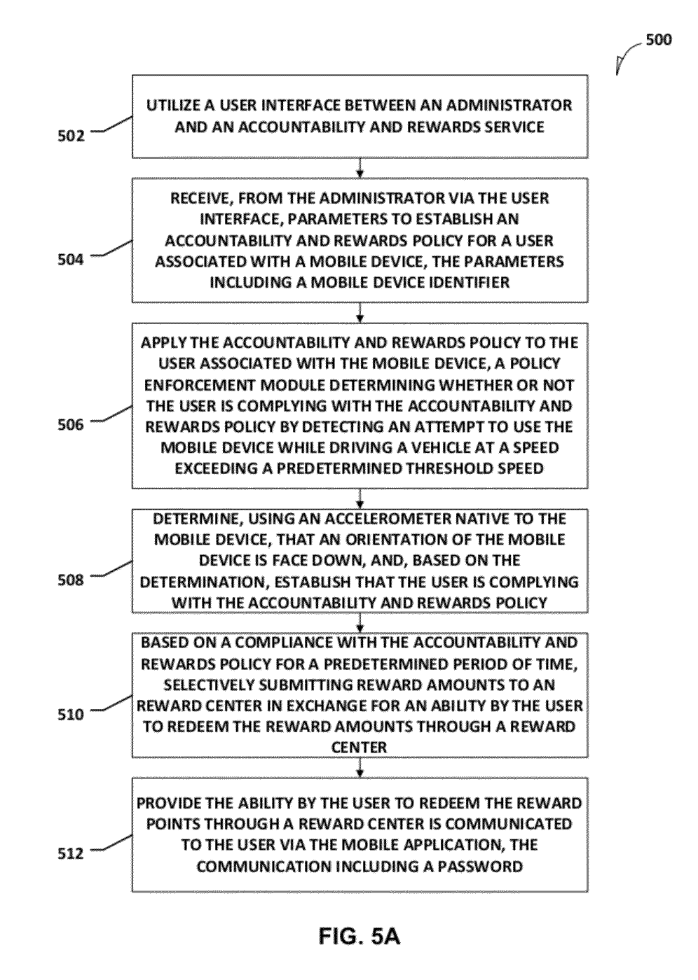

FIG. 5 is a flow chart showing a driving while distracted accountability and rewards method 500, in accordance with an example embodiment. The method 500 may be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides at the accountability and rewards system 200 illustrated in FIG. 2.

The method 500 may commence at operation 502 with the administrator 180 utilizing the sign up interface 156. At operation 504, the communication module 202 of the accountability and rewards engine 200 may receive, from the administrator 180, parameters to establish an accountability and rewards policy for the user 140. The parameters may include mobile device 150 identifier such as a MAC address or a telephone number. An administrative account may be created as part of the set up process. The information associated with the administrative account may include billing information, terms and conditions of use, user 150 information, and persons receiving notifications. As part of the set up process, the administrator 180 may be shown a video demonstrating the system.

At operation 506, the policy enforcement module 210 of the accountability and rewards engine 200 may apply the accountability and rewards policy to the user 140 associated with the mobile device 150. The policy enforcement module 210 may determine whether the user 140 is complying with the accountability and rewards policy by detecting an attempt to use the mobile device 150 while driving the vehicle 190 at a speed exceeding a predetermined threshold speed. At operation 508, the policy enforcement module 210 may determine, using an accelerometer native to the mobile device 150, that an orientation of the mobile device 150 is face down. Based on this determination, the policy enforcement module 210 may establish that the user is complying with the accountability and rewards policy.

If the user 140 complies with the accountability and rewards policy for a predetermined period of time, at operation 510, the reward module 208 may submit reward amounts to the reward center 120 in exchange for the ability by the user 140 to redeem the reward amounts through the reward center 120. At operation 512, the ability to redeem the reward amounts through the reward center 120 may be communicated to the user 140 via the mobile application 152. The communication may include a code.

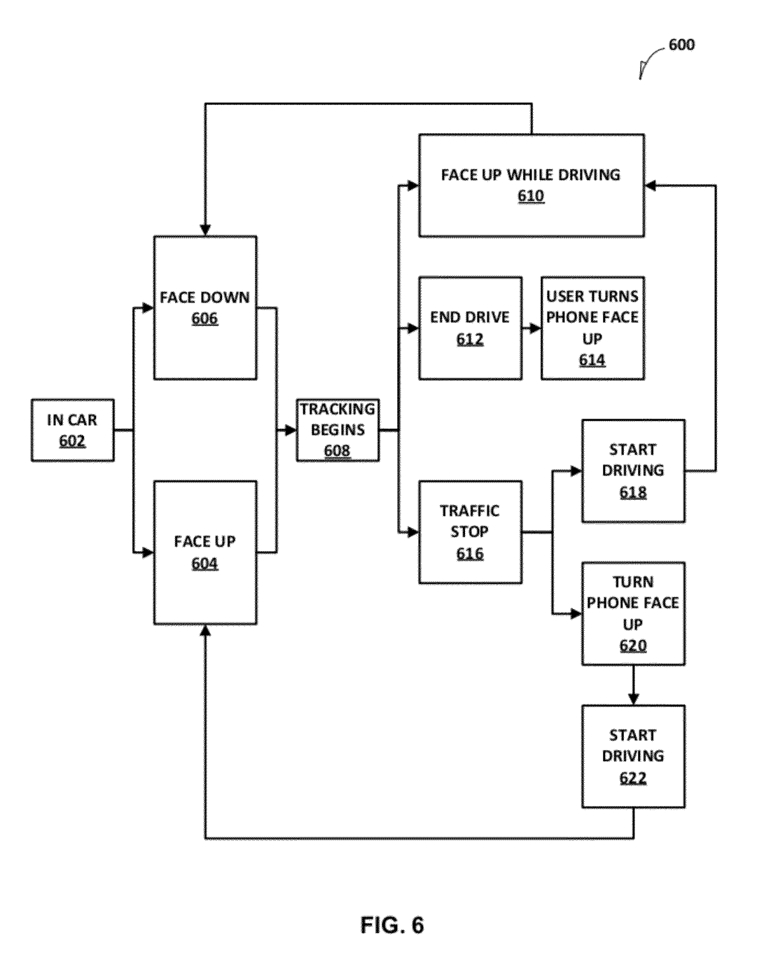

FIG. 6 is a flow chart showing a driving while distracted accountability and rewards method 600, in accordance with an example embodiment. The method 600 may be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides at the accountability and rewards system 200 illustrated in FIG. 2.

The method 600 may commence at operation 602 with the user 140 entering the vehicle 190. If, at operation 606, the vehicle 190 exceeds a predetermined threshold speed (e.g., 5 mph) and the mobile device 150 is face down as determined by the processing module 204, based on the information provided by the location detection system and the accelerometer native to the mobile device, the tracking may start automatically. When the mobile device 150 is facing down, the user 190 may not need to indicate whether he or she is the driver or a passenger of the vehicle 190.

If, however, the mobile device 150 is facing upward, and the vehicle 190 exceeds a predetermined threshold speed, an alarm may sound and the user 140 may be asked to select whether he or she is the driver or a passenger of the vehicle 190. The tracking of the compliance with the accountability and rewards policy may begin at operation 608. If the mobile device 150 is facing upward while the user 140 is driving the vehicle 190, a notification (e.g., an email) may be send to one or more persons selected by the administrator 180 notifying the one or more persons that a violation of the policy has occurred. Further notifications can be sent periodically (e.g., every 1 minute) if the mobile device 150 is not turned face down.

At operation 612, the processing module 204 may determine that the vehicle 190 has stopped (e.g., 0mph). Upon such determination, the tracking may stop. At operation 614, the user may turn the mobile device 150 face up and congratulation or sorry notification (depending on whether or not the policy was violated) is displayed.

At operation 616, the vehicle 190 may come to a stop at a traffic light. At operation 618, the vehicle 190 may start moving again. If the speed of the vehicle 190 is above the predetermined threshold speed and the mobile device 150 remains face down the tracking may resume automatically. If, on the other hand, at operation 620, the mobile device 150 is turned face up, congratulation or a sorry notification (depending on whether or not the policy was violated) is displayed. Once the vehicle 190 starts moving again at operation 622, the method 600 may proceed to operation 604 to determine whether the user 140 is the driver or a passenger of the vehicle 190.

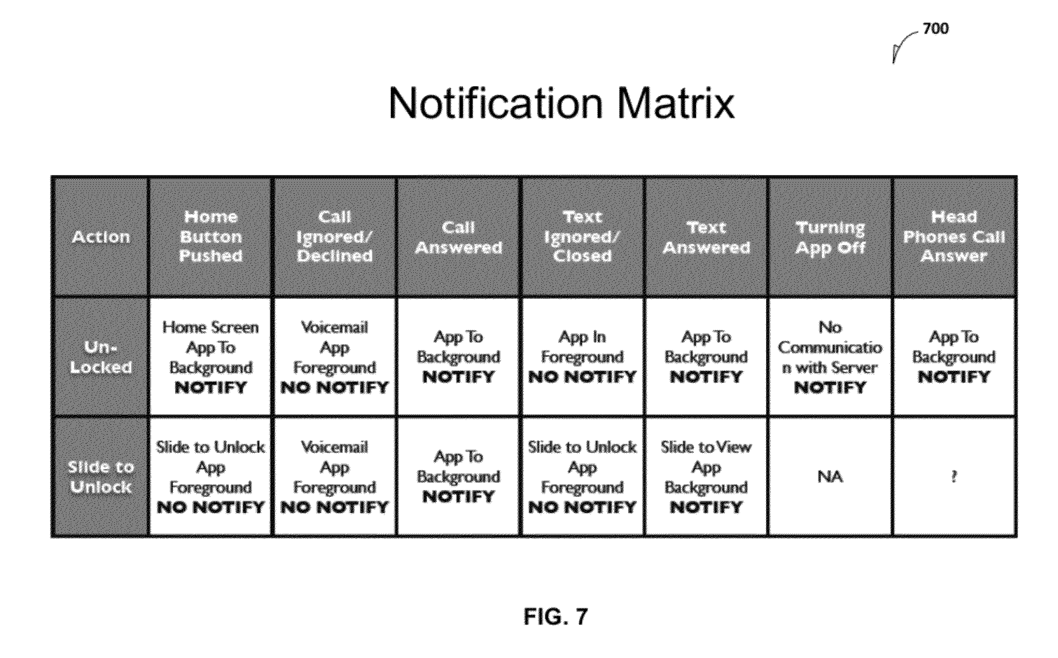

FIG. 7 is a block diagram showing a notification matrix 700, in accordance with an example embodiment. In addition to the actions shown, flipping the mobile device 150 by the user 140 may be utilized. Because the mobile device 150 may have an accelerometer built in, it can be determined that the mobile device 150 is facing down. This feature may be used to determine whether the mobile device 150 is being used. The user 140 may have to flip the mobile device over/face down in order to avoid notifications being sent to the persons specified by the administrator 180.

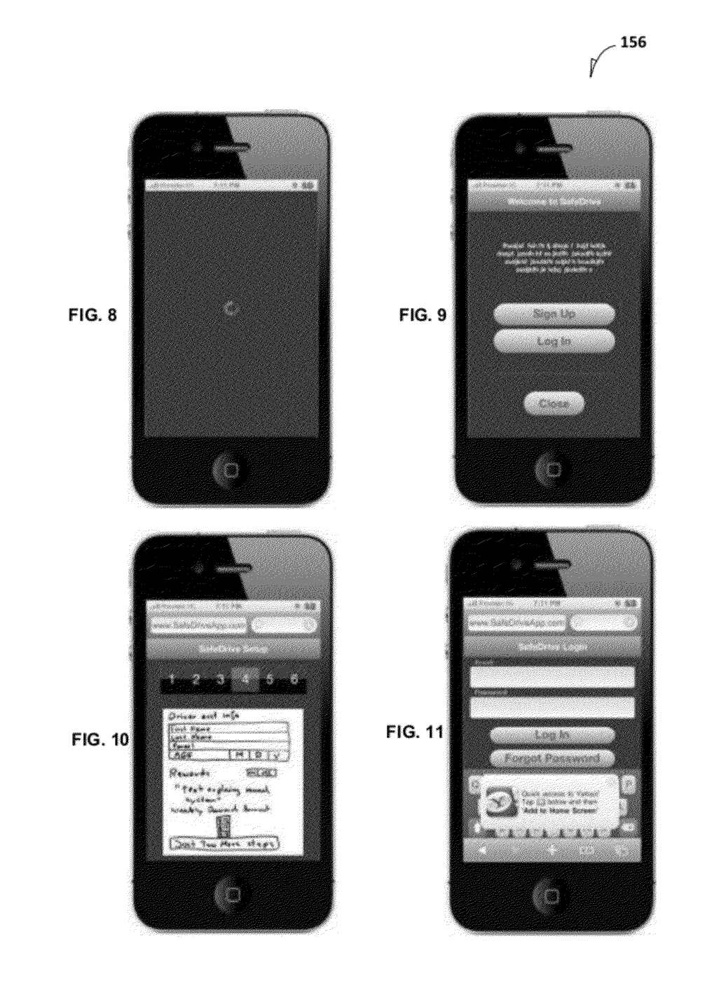

FIGS. 8-12 are block diagrams showing a sign up user interface 156, in accordance with an example embodiment. FIG. 8 shows a load screen that the administrator 180 may use to load the mobile application 152. FIG. 9 shows a welcome screen of the mobile application 152. FIG. 10 shows a message as well as log in and sign up buttons. The message may ask the administrator 180 to verify that the mobile device 150 is associated with the user 140. The sign up button may allow the administrator 180 to continue with the sign up process. Upon conclusion of the sign up process, the administrator 180 may be prompted to go back and log in the mobile application 152 using the log in button. The mobile application 152 may ask the administrator 180 to enter email and password.

FIG. 10 shows initial set up pages. For example, as shown in FIG. 11, set up pages may have a navigation bar with 1, 2, 3, 4, and 5 displayed as steps. The current step may be highlighted. Each step may have its corresponding information icon explaining the step. For example, the administrative account information may be provided in step 1. Step 2 may be utilized to set up billing information. Step 3 may be utilized to have the administrator sign the terms and conditions associated with the use of the service. The terms and conditions may be spelled out and an opt-in check box provided. Step 4 may be utilized to collect user and reward information. A message may be sent to the user 140 once the information is entered. Step 5 may be utilized to collect information related to one or more persons for notification purposes as specified by the administrator 180. A message may be sent to the one or more persons once the information is entered. Step 5 may be utilized to demonstrate the functionalities of the service with an optional video.

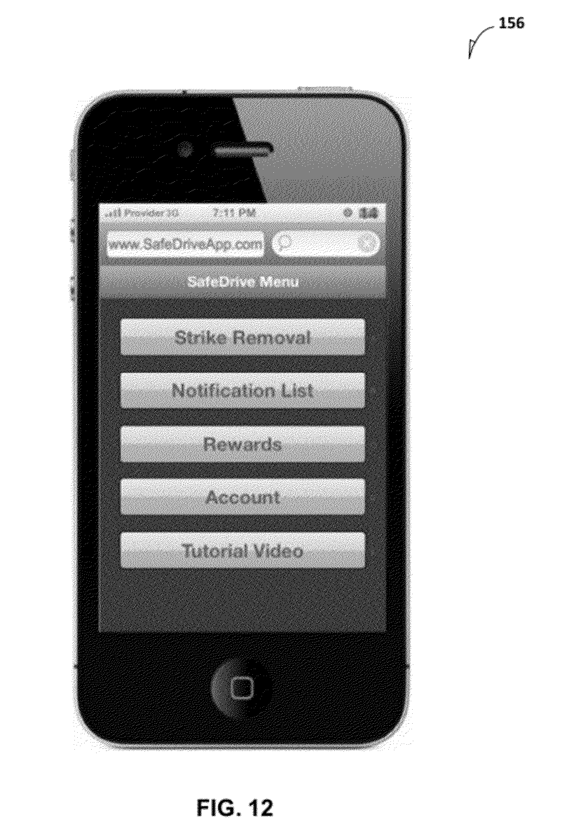

FIG. 11 shows a login page that the administrator 180 may use to log in. The login page may be a part of the mobile application 152 or web-based. The log in page may include a user name and password. FIG. 12 shows a settings/menu page, which may also be web-based. The settings/menu page may include a strike removal, notification list, rewards, account, and tutorial video links. When clicked, each of these links will direct users to an appropriate webpage.

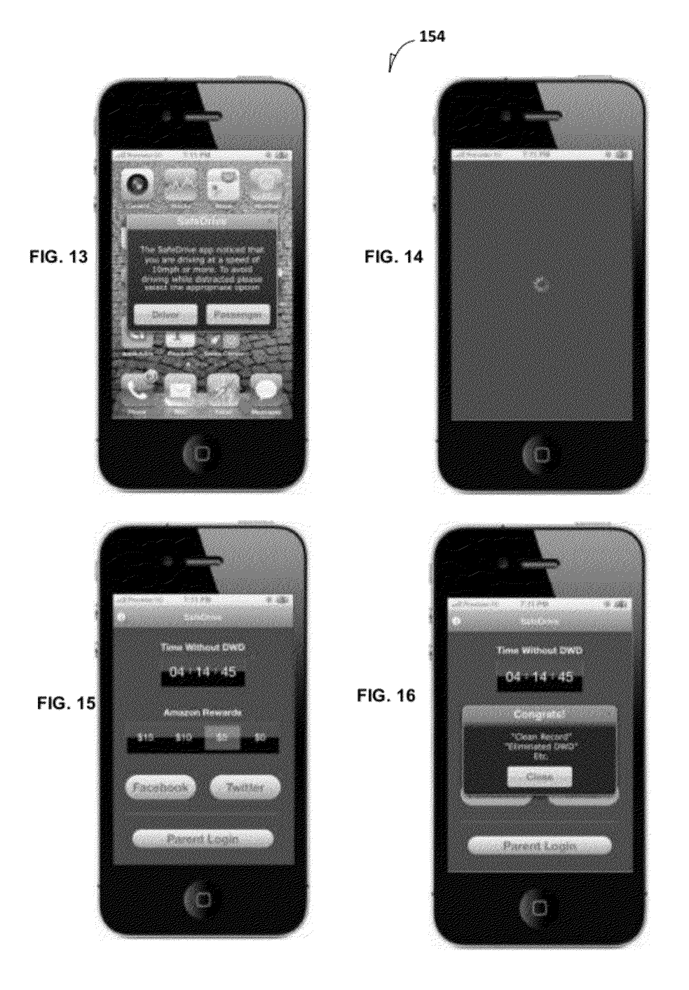

FIGS. 13-20 are block diagrams showing the user interface 154, in accordance with an example embodiment. FIG. 13 shows an initial safe drive notification alert. A notification to the user 140 may be sent via the location detection system. The notification may include a custom sound alerting the user 140 until answered. At this point, the user 140 may have an option to either specify that he or she is a passenger or the driver of the vehicle 190. If the passenger is selected, the notification system is not is not engaged and the persons specified for notifications can be sent notifications that the user 140 has chosen to ride as a passenger. If, on the other hand, the driver is selected, the notification system may be engaged and the user 140 may be prompted to turn the mobile device 150 face down.

FIG. 14 shows a load page that the user 140 may see. A logo icon and a background color may be displayed as the mobile application 152 is loading. FIG. 15 shows statistics associated with the user 140. FIG. 15 shows a home page and may provide the user 140 with information on every feature of the mobile application 152. The information may include a time of driving without being distracted. The counter may be similar to the mobile device's 150 native stopwatch application and show hours and minutes. The mobile application 152 may track every time the mobile application 152 is engaged. If the user 140 engages in driving while distracted, the time may be reset to zero and the user 140 notified with a failure notification.

The home page, for example, may display multiple reward numbers: maximum number set by the administrator 180, ⅔ of the maximum, ⅓ of the maximum, and zero. Each driving while distracted notification that the driver receives may decrease his or her reward amounts by a third. Graphically represented on the home page, a box may signal the amount of reward available. The reward counter may run in periodic (e.g., weekly) cycles: at the end of the period, the mobile application 152 may contact the reward center 120 to request a gift. In response, the reward center 120 may send a code. The synchronization module 206 of the accountability and rewards engine 200 may receive a code and send it to the user 140 via, for example, email. The user 140 may receive the email with the code and redeem the reward amounts at the reward center 120. An authorized user may have to approve the reward before it is ordered to the reward center 120.

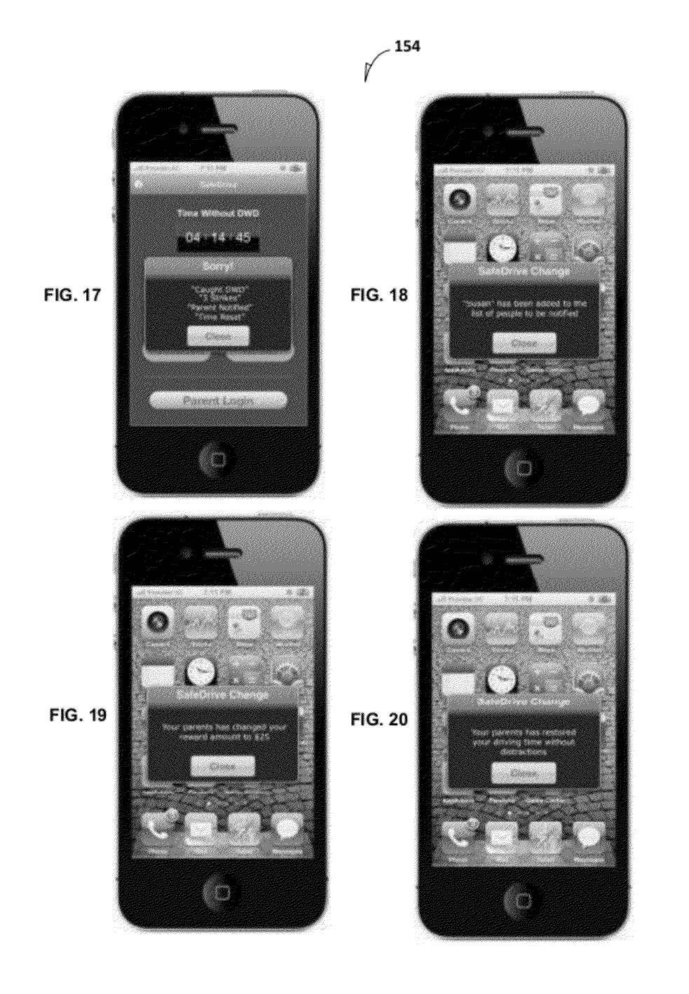

The administrator 180 may receive an email summary report of user 140's driving habits and rewards, with a share box and link to the site, as well as the reward center 120 receipt. The user 140 may share the driving statistics via, for example, Facebook and/or Twitter logo buttons. The home page may also include an administrative log in button. If, at the end of the trip, no driving while distracted violations are detected, a congratulations notification which congratulates the user 140 on his or her clean record pops up in FIG. 16. If, at the end of the trip, a driving while distracted violation is detected, a sorry message pops up in FIG. 17. The message explains to user 140 that he or she has engaged in driving while distracted, shows the number of strikes, and how the total reward amount has been decreased.

Notifications may be sent to one or more persons specified by the administrator 180. If a notification happens in the beginning of the trip, the timer on the home page may be reset but it may not start recording time without driving while distracted until the trip is over. If, for example, there are multiple violations over the course of one trip, only one notification indicating multiple strikes may be sent.

FIGS. 18-20 show notifications (e.g., emails) received by the user 140 when settings changes occur. If, for example, the administrator 180 changes the settings via the mobile device 150 or using an Internet webpage, the user 140 may be informed via the notification. A notification can be received when a person is added to the notification list, the reward system 120 has been changed, the administrator 180 has overwritten the last notification, or reward amounts have been restored.

FIG. 21-28 are block diagrams showing the administrative user interface 158, in accordance with an example embodiment. FIG. 21 shows a home page and may provide the user 140 with information on every feature of the mobile application 152. The information may include a time of driving without being distracted. The counter may be similar to the mobile device's 150 native stopwatch application and show hours and minutes. The mobile application 152 may track every time the mobile application 152 is engaged. If the user 140 engages in driving while distracted, the time may be reset to zero and the user 140 notified with a failure notification.

The home page, for example, may display multiple reward numbers: maximum number set by the administrator 180, ⅔ of the maximum, ⅓ of the maximum, and zero. Each driving while distracted notification that the driver receives may decrease his or her reward amounts by a third. Graphically represented on the home page, a box may signal the amount of reward available. The reward counter may run in periodic (e.g., weekly) cycles: at the end of the period, the mobile application 152 may contact the reward center 120 to request a gift. In response, the reward center 120 may send a code. The synchronization module 206 of the accountability and rewards engine 200 may receive a code and send it to the user 140 via, for example, email. The user 140 may receive the email with the code and redeem the reward amounts at the reward center 120.

The administrator 180 may receive an email summary report of user 140's driving habits and rewards with a share box and link to the site, as well as the reward center 120 receipt. The user 140 may share the driving statistics via, for example, Facebook and/or Twitter logo buttons. The home page may also include an administrative log in button.

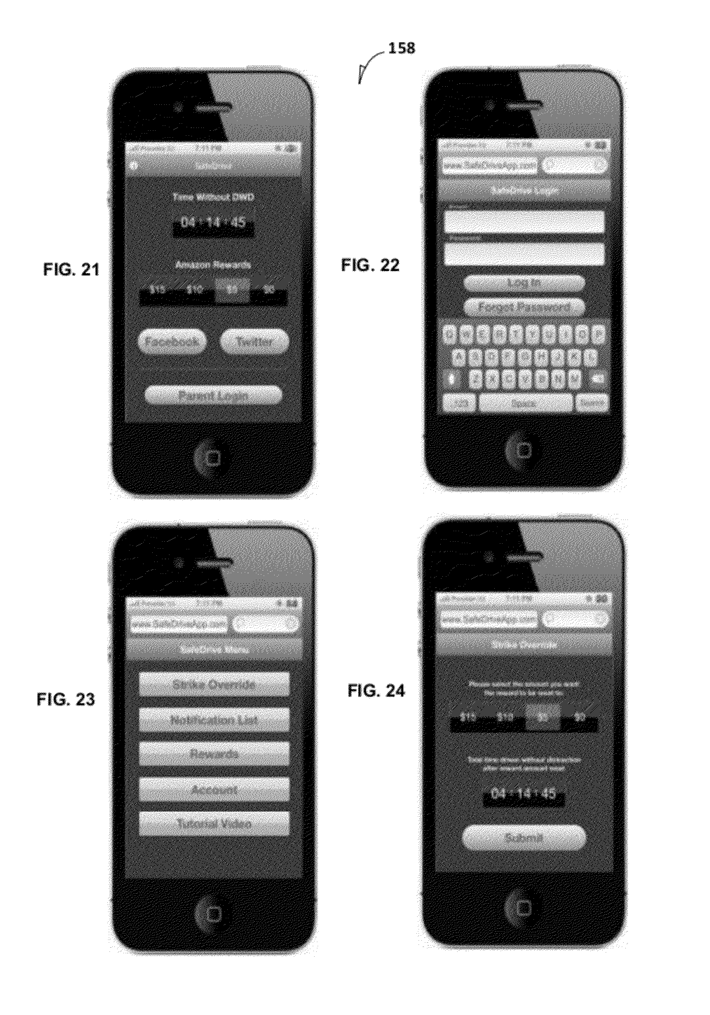

FIG. 22 shows a log in page that the administrator 180 may use to log into the administrative section of the mobile application 152. FIG. 23 shows a settings/menu page, which may also be web-based. The settings/menu page may include a strike removal, notification list, rewards, account, and tutorial video links. When clicked, each of this links will direct to an appropriate webpage.

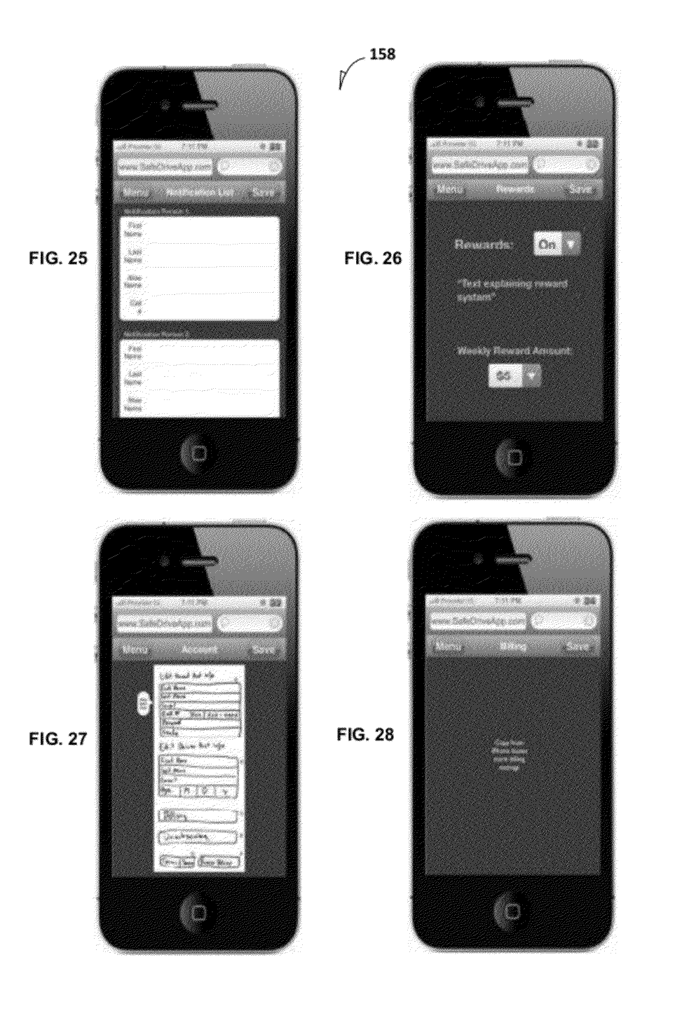

FIGS. 23 and 24 illustrate the process the administrator 180 may go through to remove a strike from the record of the user 140. FIG. 25 illustrates a notification list, which can be set up by the administrator 180 to notify one or more persons. Each person may have a record represented by multiple information text fields. For example, each person may have information text fields representing a name, email, and mobile telephone number. Additionally, an alias name may be created (e.g., “Mom” or “Dad”). When a new person is added to the notification list, the page may send the information to be stored in the administrator demographical database 112. The administrator demographical database 112 may send an email to the new person telling them that they are now going to receive notifications (e.g., driving while distracted notifications, successful driving notifications, and weekly reports). The page may include a save button, which when pushed, saves changes and sends notification the user 140.

FIG. 26 shows a page, which can be used by the administrator 180 to enable or disable the rewards feature and to set a periodic reward amount. FIG. 27 shows an account settings page which can be used to edit the administrator account information. The settings page may include multiple text fields. For example, the settings page may include first name, last name, email, mobile telephone number, password, password verification, and alias name. The information related to the administrator 180 may be saved to the administrator demographical database 112. The database may send the administrator 180 an automatic confirmation email. The settings page also includes multiple text fields for the user 140. For example, first name, last name, mobile telephone number, and age text fields may be provided. The information related to the user 140 may be saved to the demographical database 114. The settings page may also provide links to the billing, unsubscribe, terms of service, and privacy pages. FIG. 28 shows a billing page.

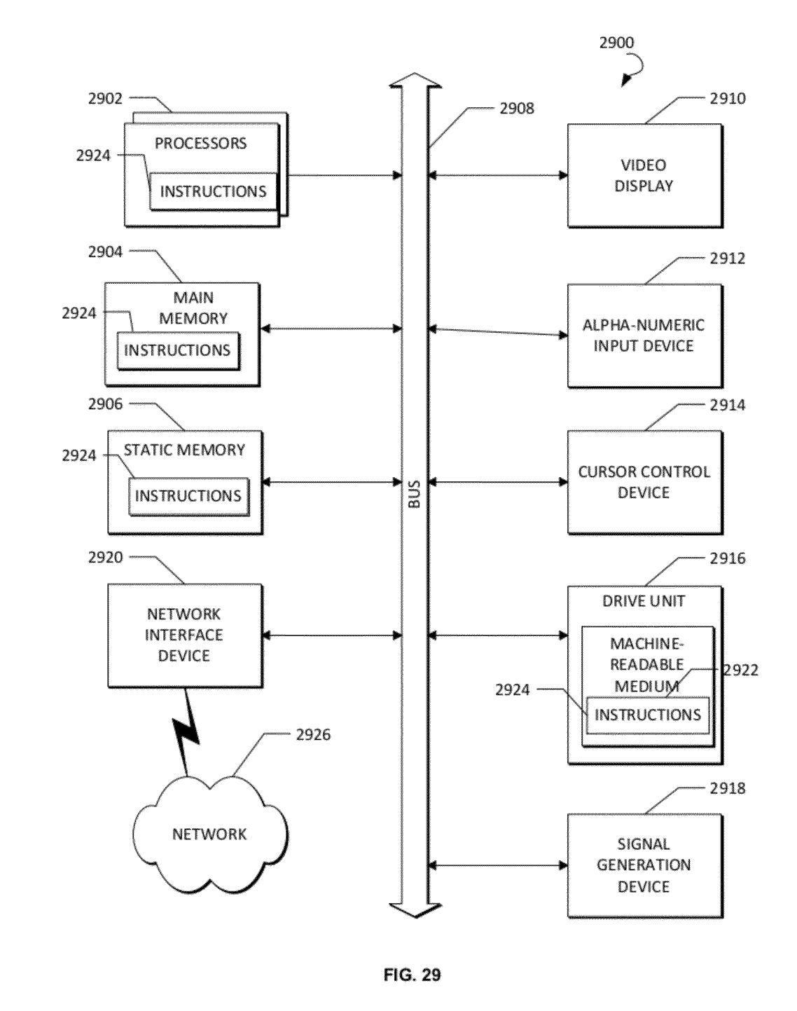

FIG. 29 is a diagrammatic representation of an example machine in the form of a computer system 2900, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2900 includes a processor or multiple processors 2902 (e.g., a central processing unit (CPU), a graphics processing unit (GPU), or both), and a main memory 2904 and static memory 2806, which communicate with each other via a bus 2908. In some example embodiments, the computer system 2900 is a mobile device (e.g., the mobile device 150 shown in FIG. 1). The computer system 2900 may further include a video display unit 2910 (e.g., a liquid crystal display (LCD)). The computer system 2900 may also include an alpha-numeric input device 2912 (e.g., a keyboard), a cursor control device 2914 (e.g., a mouse), a voice recognition or biometric verification unit, a disk drive unit 2916, a signal generation device 2918 (e.g., a speaker) and a network interface device 2920. The computer system 2900 may further include a data encryption module (not shown) to encrypt data.

The disk drive unit 2916 includes a computer-readable medium 2922 on which is stored one or more sets of instructions and data structures (e.g., instructions 2924) embodying or utilizing any one or more of the methodologies or functions described herein. The instructions 2924 may also reside, completely or at least partially, within the main memory 2904 and/or within the processors 2902 during execution thereof by the computer system 2900. The main memory 2904 and the processors 2902 may also constitute machine-readable media.

The instructions 2924 may further be transmitted or received over a network 2926 via the network interface device 2920 utilizing any one of a number of well-known transfer protocols (e.g., Hyper Text Transfer Protocol (HTTP)).

While the computer-readable medium 2922 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, driving while distracted accountability and rewards systems and methods have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method for driving while distracted accountability and rewards, the method comprising:
utilizing a user interface between an administrator and an accountability and rewards service;
receiving, from the administrator via the user interface, parameters to establish an accountability and rewards policy for a user associated with a mobile device, the parameters including a mobile device identifier;
applying the accountability and rewards policy to the user associated with the mobile device, a policy enforcement module determining whether or not the user is complying with the accountability and rewards policy by detecting an attempt to use the mobile device while driving a vehicle at a speed exceeding a predetermined threshold speed; and
based on a compliance with the accountability and rewards policy for a predetermined period of time, selectively submitting reward amounts to an reward center in exchange for an ability by the user to redeem the reward amounts through the reward center.

2. The computer-implemented method of claim 1, wherein the rewards amounts are reduced in response to the noncompliance or increased in response to compliance.

3. The computer-implemented method of claim 2, wherein one or more persons specified by the administrator are notified of the noncompliance occurrence.

4. The computer-implemented method of claim 1, wherein the speed of the vehicle is determined based on information provided by a location detection system native to the mobile device.

5. The computer-implemented method of claim 1, further comprising a mobile application installed on the mobile device allowing the user to notify the policy enforcement module that the user is not driving the vehicle, thereby disabling the accountability and rewards policy.

6. The computer-implemented method of claim 1, further comprising:
determining, using an accelerometer native to the mobile device, that an orientation of the mobile device is face down; and
based on the determination, establishing that the user is complying with the accountability and rewards policy.

7. The computer-implemented method of claim 1, wherein the mobile application displays information related to the compliance with the accountability and rewards policy.

8. The computer-implemented method of claim 1, wherein the ability by the user to redeem the reward amounts through the reward center is communicated to the user via the mobile application, the communication including a code.

9. The computer-implemented method of claim 1, wherein the mobile device allows sharing statistics associated with the compliance.

10. The computer-implemented method of claim 1, wherein the administrator modifies the accountability and rewards policy after the predetermined period of time has commenced.

11. A system for driving while distracted accountability and rewards, the system comprising:
a user interface between an administrator and an accountability and rewards service;
a communication module to receive, from the administrator via the user interface, parameters to establish an accountability and rewards policy for a user associated with a mobile device, the parameters including a mobile device identifier;
a policy enforcement module to apply the accountability and rewards policy to the user associated with the mobile device, the policy enforcement module determining whether or not the user is complying with the accountability and rewards policy by detecting an attempt to use the mobile device while driving a vehicle at a speed exceeding a predetermined threshold speed; and
an reward module to selectively submit reward amounts to an reward center in exchange for an ability by the user to redeem the reward amounts through the reward center, based on a compliance with the accountability and rewards policy for a predetermined period of time.

12. The system of claim 11, wherein the rewards amounts are reduced in response to the noncompliance or increased in response to compliance.

13. The system of claim 11, wherein one or more persons specified by the administrator are notified of the noncompliance.

14. The system of claim 11, wherein the speed of the vehicle is determined based on information provided by a general location detection system native to the mobile device.

15. The system of claim 11, further comprising a mobile application installed on the mobile device, wherein the mobile application allows the user to notify the policy enforcement module that the user is not driving the vehicle, thereby deactivating the accountability and rewards policy.

16. The system of claim 11, wherein the policy enforcement module determines, using an accelerometer native to the mobile device, that an orientation of the mobile device is face down, and, based on the determination, establishing that the user is complying with the accountability and rewards policy.

17. The system of claim 11, wherein the mobile application displays information related to the compliance.

18. The system 11, wherein the mobile device allows sharing statistics associated with the compliance.

19. The system 11, wherein the administrator modifies the accountability and rewards policy after the predetermined period of time has commenced.

20. A machine-readable medium comprising instructions for driving while distracted accountability and rewards, which when implemented by one or more processors, performs the following operations:
utilize a user interface between an administrator and an accountability and rewards service;
receive, from the administrator via the user interface, parameters to establish an accountability and rewards policy for a user associated with a mobile device, the parameters including a mobile device identifier;
apply the accountability and rewards policy to the user associated with the mobile device, a policy enforcement module determining whether or not the user is complying with the accountability and rewards policy by detecting an attempt to use the mobile device while driving a vehicle at a speed exceeding a predetermined threshold speed; and
based on a compliance with the accountability and rewards policy for a predetermined period of time, selectively submit reward amounts to an reward center in exchange for an ability by the user to redeem the reward amounts through an reward center.
